(19) United States
(12) Patent Application Publication
(10) Pub. No.: US 2005/0021163 A1
(43) Pub. Date: Jan. 27, 2005

(54) Alignment and comparison of free-form surfaces

(75) Inventors: Peihua Gu, Calgary (CA); Yadong Li, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: University Technologies International Inc.

(21) Appl. No.: 10/791,723

(22) Filed: Mar. 4, 2004

Related U.S. Application Data
(60) Provisional application No. 60/320,288, filed on Jun. 19, 2003.

(51) Int. Cl. G06F 19/00

(52) U.S. Cl. 700/95

(57) ABSTRACT

A method is disclosed for the alignment of free-form surfaces having arbitrary initial positions. The method includes the steps of extracting surface information from two free-form surfaces to determine surface characteristics, partitioning surfaces into regions based on the surface characteristics, and comparing regions on the first free-form surface and the second free-form surface to determine corresponding regions, then these two surfaces are generally aligned. Next at least three pairs of corresponding points from the first and second free-form surfaces are determined from the corresponding regions, and the first and second free-form surfaces are localized to obtain a plurality of corresponding points. The difference between the points in each pair of corresponding points is then determined.

### FIELD OF THE INVENTION

This invention relates generally to methods and systems for aligning and comparing free-form surfaces.

### BACKGROUND

Free-form surfaces, or complex surfaces, are used widely in many fields with applications growing continuously from traditional tool and die making, the design and manufacturing of patterns and models, plastics, automotive, aerospace, biomedical, entertainment and geographical data. Specifically, in designing and manufacturing a free form surface, a manufactured or reconstructed part is compared to the free form surface of design specifications to verify conformance.

Accurate alignment of free form surfaces is required before a comparison between the two free form surfaces can be made. Unfortunately, the necessary accurate alignment is difficult to achieve. Methods disclosed in U.S. Pat. No. 5,481,483 and U.S. Pat. No. 5,384,717 use the determination of dimensional information of a boundary, such as the location and radius of a circular reference feature. The method disclosed in U.S. Pat. No. 5,319,567 uses the determination of dimensional information of a selected reference feature having a planar boundary. The method disclosed in U.S. Pat. No. 5,991,703 obtains measurement data of free-form surfaces based on local shapes such as mountain, valley, and peak using principal curvature as an evaluation model. The method disclosed in U.S. Pat. No. 5,546,328 requires that the two free-form surfaces be in crude alignment in the same coordinate frame before a more accurate automatic alignment can be performed. The selection of a reference feature or crude alignment in coordinate frame, characteristic of the prior art methods typically require the time and expense of a skilled operator.

Therefore, there is a need in the art for methods and systems for aligning and comparing free-form surfaces which are automatic or less labour intensive than those found in the prior art.

### SUMMARY OF THE INVENTION

This invention provides for a method for automatically aligning free-form surfaces having arbitrary initial positions based on the determination of corresponding regions followed by the determination of corresponding points for determining the differences between those free-form surfaces.

In one aspect, the invention comprises a computer-implemented method of:
(a) extracting surface information from each of the first and second free-form surfaces for determining surface characteristics;
(b) partitioning each of the first and second free-form surfaces into at least three regions, wherein each region is characterized by a surface characteristic(s);
(c) for each of the first and the second free-from surfaces, determining the position of each region relative to the other regions;
(d) comparing regions of the first free-form surface regions with those of the second free-form surface to determine corresponding regions;
(e) determining at least three pairs of corresponding points from the first and the second free-form surfaces;
(f) generally localizing the first free-form surface to the second free-form surface;
(g) selecting the corresponding points from those corresponding regions;
(h) fine localization of the first surface to the second surface;
(i) determining the difference between the points in each pair of the corresponding point sets.

In another aspect, the invention comprises a system for comparing a first free-form surface with a second free-form surface, comprising:
(a) means for extracting surface information from each of the first and second free-from surfaces for determining surface characteristics;
(b) means for partitioning each of the first and second free-form surfaces into at least three regions, wherein each region is characterized by a surface characteristic(s);
(c) means for each of the first and the second free-from surfaces, determining the position of each region relative to the other regions;
(d) means for comparing regions of the first free-form surface regions with those of the second free-form surface to determine corresponding regions;
(e) means for determining at least three pairs of corresponding points from the first and the second free-form surfaces;
(f) means for generally localizing the first free-form surface to the second free-form surface;
(g) means for selecting the corresponding points from those corresponding regions;
(h) means for fine localization of the first surface to the second surface;
(i) means for determining the difference between the points in each pair of the corresponding point sets.

In another aspect, the invention may comprise storage medium encoded with machine-readable computer program code for comparing a first free-form surface with a second free-form surface, the storage medium including instructions for causing a computer system to implement a method of the present invention as described and claimed herein.

### BRIEF DESCRIPTION OF THE DRAWINGS

The invention may now be described with reference to the following drawings.

FIG. 1 is a schematic flowchart describing the steps of a method of the present invention.

FIG. 2A is a view of a free-form surface before region partitioning.

FIG. 2B is a view of the same free-form surface after region partitioning.

FIG. 3 is a view of matched regions between first and second free-form surfaces which are not aligned.

FIG. 4 is a block diagram of one embodiment of a computer system for aligning and comparing two free-form surfaces.

### DETAILED DESCRIPTION OF PREFERRED EMBODIMENTS

The present invention provides a method and system for comparing two free-form surfaces. One free-form surface, alternatively called a first surface, or a reference surface is a design model which represents the surface shape which is intended to be produced. The other free-form surface, alternatively called a second surface, or a measurement surface, is the manufactured or produced model. The present invention provides means for determining the differences between the manufactured model from the design model.

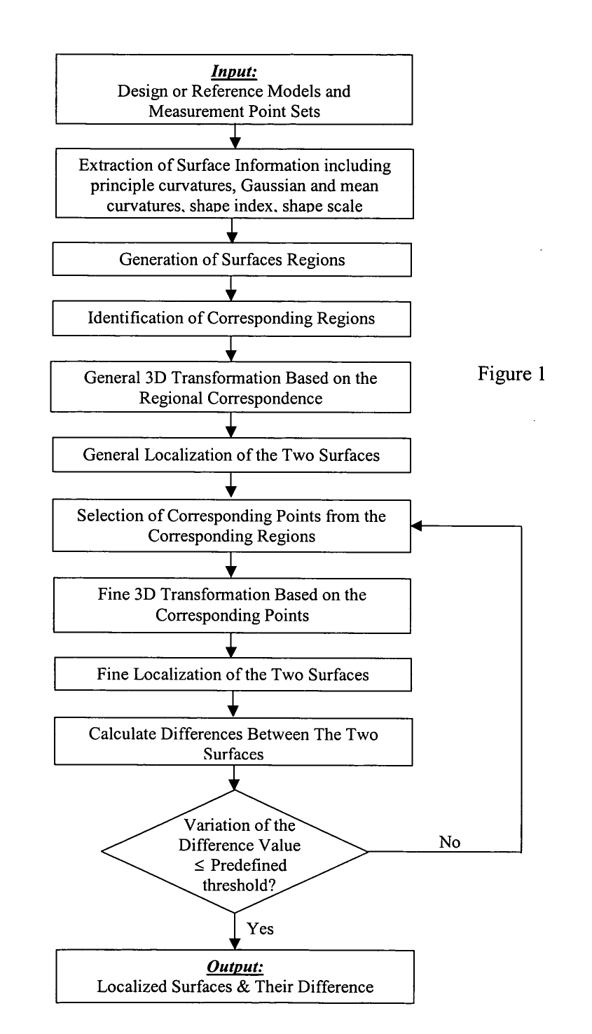

A schematic flowchart representation of one embodiment of the present invention is shown in FIG. 1. The reference free-form surface (first surface) as well as the measurement free-form surface (second surface) must be reduced to a set of measurement points or a mathematical model. The reference surface may preexist as a mathematical model. As used herein, a “reference model” means the designed or scanned surface model. The measurement of a physical surface to produce a set of measurement points may be performed using a laser scanner or a coordinate measuring machine, as is well known in the art.

As used herein, a “free-form surface” shall mean a surface which is not defined analytically such as conic surfaces such that its shape is not constrained by classical analytical forms. A free-form surface is defined by a set of control points, as with Bézier, b-spline, and NURBS surfaces. Free-form surfaces are also known as sculptured surfaces. A free-form surface may have surface information or surface characteristics such as Gauss curvature, mean curvature, principle curvatures, shape index, shape scale and regional area relevant to an individual region within the surface area.

Once a measurement set for each of the first and second surfaces is available, the next step is to extract surface information from each of the first and second free-from surfaces for determining surface characteristics. Surface information may include principle curvatures, Gaussian curvature, mean curvature, shape index and shape scale are calculated. In one example, a free-form surface in the parametric form is denoted as P, and the parameters describing the surface are u and v. The following information may be calculated at each surface point:

The first and second derivatives, and the surface normal of the surface are:
1^{st} derivatives: Pᵤ, Pᵥ
2nd derivatives: Pᵤᵤ, Pᵤᵥ and Pᵥᵥ
Normal: n=Pᵤ×Pᵥ
   To define the curvatures of the surface, the components of first and second fundamental forms of the surface must be found.
Components of 1^{st} fundamental form of surface P:
   E=E(u, v)=PᵤPᵤ
   F=F(u, v)=PᵤPᵥ
   G=G(u, v)=PᵥPᵥ
Components of 2nd fundamental form of surface P:
   L=L(u, v)=nPᵤᵤ
   M=M₍u, v)=nPᵤᵥ
   N=N(u, v)=nPᵥᵥ

Based on the above, the principle curvatures k₁ and k₂ may be calculated:

$${k}_{1} = \frac{L}{E} , and {k}_{2} = \frac{N}{G}$$

Gaussian curvature k:

$$k = {k}_{1} {k}_{2} = \frac{L N - {M}^{2}}{EG - {F}^{2}}$$
Mean curvature H:

$$H = {k}_{1} + {k}_{2} = \frac{NE - 2 MF + LG}{EG - {F}^{2}}$$
Relationship between principle curvatures, Gaussian curvatures and mean curvatures:
   k₁=H+\sqrt{H²−k}
   k₂=H−\sqrt{H²−k}
Shape Index SI:

$$SI = \frac{2}{π} {tan}^{- 1} ( \frac{{k}_{2} + {k}_{1}}{{k}_{2} - {k}_{1}} )$$
Shape Scale SC:

$$SC = \sqrt{\frac{{k}_{1}^{2} + {k}_{2}^{2}}{2}}$$

Once the above information is available, a surface information matrix is created to store these values.

If the surface is not described in parametric form, the above surface information can be calculated by fitting surface patches then obtaining the required information, or by direct estimation from the surface data.

After surface information has been extracted, each of the first and second free-form surfaces may be partitioned into at least three regions, wherein each region is characterized by at least one surface characteristic.

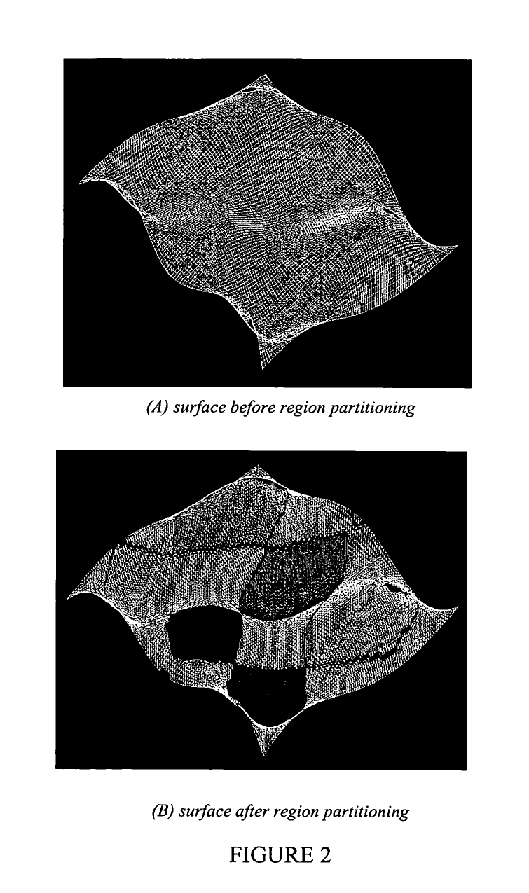

Based on the analysis of surface information matrix, points of the surface are categorized into different groups or regions based on their similarities of the shape characteristics including, without limitation, concave, convex, saddle, and plane. By doing so, both the first surface and the second surface will be partitioned into a plurality of regions, each containing points with identical or similar shape characteristics. As used herein, a “region” shall mean an area consisting of points that are neighboring to each other and have similar surface shape type such as concave, convex, saddle or plane. As shown in FIG. 2, a free-form surface may comprise several regions.

For each surface, the average values obtained from all the points inside an individual region are taken as the surface information of this region. In addition, the area of a region is also calculated as an item surface information. The values of these surface characteristics will be used as the comparison criteria in selecting matching regions between the first and the second surfaces.

It is then possible to determine the position of each region relative to other regions, for each of the first and the second free-from surfaces. As used herein, “position” shall mean the location and orientation of a geometric element such as a point, a surface patch and the like in three-dimensional space.

In three-dimensional space, an arbitrary region A of a surface has positional relationship with other regions of the surface, which includes:
neighboring Relationship: region A is connected to its neighboring regions;
spatial Distance Relationship: region A has its identical distances to other regions (use the average centers of the regions, and region A has its identical distance to the surface center).

The relative positional relationships between these regions may then be used as an evaluation criterion for region matching.

The next step is to compare regions of the first free-form surface regions with those of the second free-form surface to determine corresponding or matching regions. Corresponding regions are those regions, one each from the reference and measurement surfaces, which have the most similar surface characteristics.

In one embodiment, correspondence between the first surface and the second surface is firstly established based on selecting the corresponding regions between these two surfaces. The corresponding regions of these two surfaces are determined based on the evaluation of:
1. Surface characteristics: the corresponding regions should have the same or very close surface characteristics and geometric attributes which are obtained from the initial steps described above.
2. 3D positional information obtained as described above.

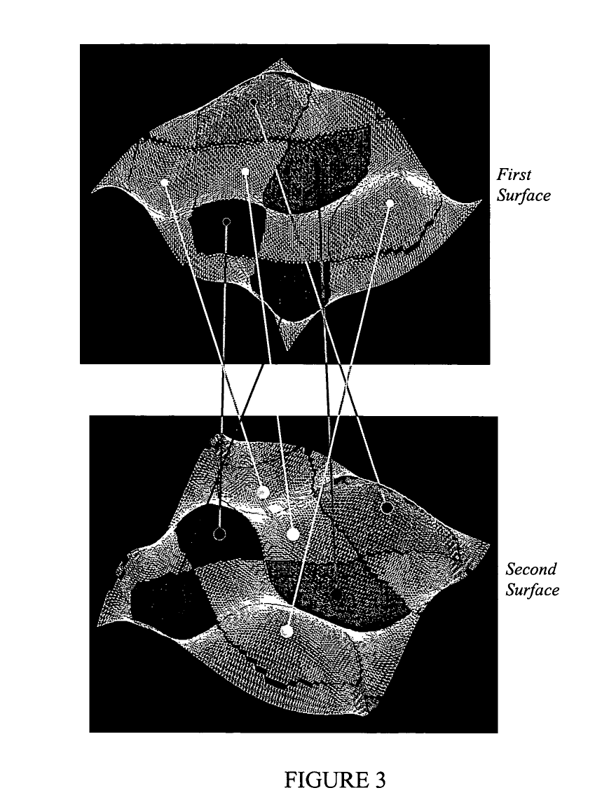

After evaluation, two regions with the smallest difference in these comparison criteria are marked as the matching regions. FIG. 3 shows matched regions between a reference surface and a measurement surface.

Once corresponding regions are identified in the first and second surfaces, the next step is to determine matching pairs of corresponding points from the two surfaces. For every point on reference surface, there exists a corresponding point on the measurement surface, which is manufactured according to the design model. This pair of points is referred to herein as corresponding points. The corresponding points of the two surfaces can be selected from the relative center points of two corresponding regions. Alternatively, the corresponding points may be selected from the points having the most similar surface characteristics from inside the corresponding regions. In one embodiment, at least three pairs of corresponding points are determined from the two surfaces.

In one embodiment, localization of the first free-form surface to the second free-form surface is carried out in two steps. First a general localization is performed followed by a specific localization. Localization is a process where the measurement surface is compared with the reference surface after aligning the two surfaces in a common coordinate system.

Based on the above correspondence in points, general localization is carried out to localize one surface to the other. In one embodiment, this is implemented by applying a rigid 3D transformation(s) to that surface being localized. In one embodiment, a linear process model is utilized to determine transformation matrix T based on the corresponding relationship and the minimization of the surfaces distance using the least square principle. As used herein, “transformation” means the operation of changing (as by rotation, translation or mapping) one configuration or expression into another in accordance with a mathematical rule; or a change of variables or coordinates in which a function of new variables or coordinates is substituted for each original variable or coordinate. Similarly, a “translation” means a transformation of coordinates in which the new axes are parallel to the old ones, or uniform motion of a body in a straight line. The term “rotation” means the action or process of rotating on or as if on an axis or center. In this application, it indicates the process of surface rotation around an arbitrary axis.

Transformation matrix T is determined as follows. If rᵢ^{*} denote an arbitrary point on the first surface and rᵢ denote the corresponding point from the second surface, than transformation matrix T that localizes the first surface to the second surface can be determined by following process:

$$T = [ \begin{matrix}{t}_{11} & {t}_{12} & {t}_{13} & {t}_{14} \\ {t}_{21} & {t}_{22} & {t}_{23} & {t}_{24} \\ {t}_{31} & {t}_{32} & {t}_{33} & {t}_{34} \\ 0 & 0 & 0 & 1\end{matrix} ]$$

At first, calculate the distance between localized point rᵢ^{*} and its corresponding point rᵢ:
dᵢ=Tᵣ^{*}−rᵢ
Then find the squared distance between these two points:
fᵢ=dᵢ²=(Trᵢ^{*}−rᵢ)^{T}(Tᵣᵢ^{*}−rᵢ)
The total of the squared distances of all the above points on these two surfaces is F

$$F = {\sum }_{i = 1}^{m} {f}_{i}$$

Transformation matrix, T, can be decided based on the criterion that it will make F minimum. By minimizing F with respect to the elements of T, the elements of matrix T can be calculated

$$\frac{\partial F}{\partial {t}_{ij}} = 0$$

General localization aligns those two surfaces close to each other. The next step is to carry out the fine localization so as to enable the surface comparison. To do so, more corresponding points from these two surfaces need to be decided for the fine localization.

These corresponding points are selected from inside of the corresponding regions of the two surfaces. The criteria for selecting the corresponding points in this step are:
they are from corresponding regions;
they have the closest surface characteristic values (the values calculated above;) and
they are close to each other in distance.

Corresponding points may be determined by an Iterative Closest Point (ICP) algorithm which is a method that decides corresponding points by choosing the closest points on reference and measurement surfaces in an iterative way. An iterative process is one in which repetition of a sequence of operations yields results successively closer to a desired result. Iterative processes may include the repetition of a sequence of computer instructions a specified number of times or until a specified condition is met.

In one embodiment, the Newton method is used to find the closest point in the process of selecting corresponding points. In some cases, particularly the boundary points of the surfaces, this method may not be stable or may not give solutions. In this event, a subdivision method may be utilized to solve the problem. In a subdivision method, the closest point is firstly chosen from a selected region. Then the search continues with the subdivision of that region, which reduces the search range to a smaller portion of the area. The search of the closest point will stop when the subdivision step is small enough.

After general localization and matching of corresponding points, a fine localization of the first surface to the second surface may be performed.

Based on the corresponding result obtained from the above step, the fine localization can be carried out to localize the first surface to the second surface such that the sum of the squared differences between all the corresponding points is minimized. The 3D transformation in this operation is determined in a similar manner as in the general localization process.

Once a general and a fine localization has been carried out, the difference between the points in each pair of the corresponding point sets may be determined. The difference between two corresponding points is calculated on a point by point basis. Fine localization is complete when the sum of the squared differences reaches a pre-defined threshold value. If the threshold value is not reached, the fine localization process may be repeated until the threshold is reached.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

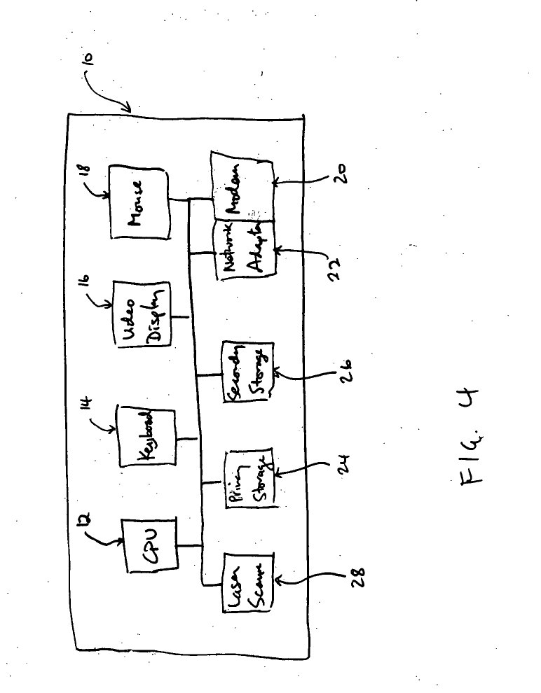

One embodiment of a system of the present invention is shown schematically in a block diagram in FIG. 4. The computer system (10) shown in FIG. 4 includes a central processor unit (12) for executing instructions. A number of peripheral devices, including a keyboard (14), a video display (16), and a mouse (18), may be provided as part of the computer system (10). A modem (20) may be provided to allow the computer system to communicate over analog telephone lines, and/or a network adapter (22) may be provided to facilitate the connection of the computer system (10) to a local area network (LAN). The computer (10) may also include other components, such as a cable modem, for facilitating remote communications with a remote server (not shown).

The computer system (10) includes both primary storage (24) and secondary storage (26). The secondary storage (26) may include a number of different types of persistent storage. For example, the secondary storage (26) may include CD-ROM, floppy disks, hard disks and or any other suitable computer-readable medium, including other devices that use optical, magnetic or other recording material. The primary storage (24) may also include a number of different types of well-known storage, such as DRAM, SRAM, and the like.

The computer system (10) further includes a facility for generating a mathematical model of an object or a free-form surface. The system may be linked to a laser scanner (28) or similar equipment. Additionally, or alternatively, a computer-aided design system (CAD/CAM) may be incorporated for producing a model corresponding to surfaces of an object or an assembly of a plurality of objects. In one embodiment, the CAD/CAM system is used to provide the reference free-form surface, while the measurement surface is obtained from the laser scanner system. The display unit (16) can provide a visual depiction of either or both the free-form surfaces.

The secondary storage device (26) may store executable instructions for aligning and comparing two free-form surfaces in accordance with the methods of the present invention. Those skilled in the art will appreciate that the computer system shown in FIG. 4 is intended to be merely illustrative and not limiting of the present invention.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A computer-implemented method of comparing a first free-form surface with a second free-form surface, comprising the steps of:
(a) extracting surface information from each of the first and second free-form surfaces for determining surface characteristics;
(b) partitioning each of the first and second free-form surfaces into at least three regions, wherein each region is characterized by a surface characteristic(s);
(c) for each of the first and the second free-from surfaces, determining the position of each region relative to the other regions;
(d) comparing regions of the first free-form surface regions with those of the second free-form surface to determine corresponding regions;
(e) determining at least three pairs of corresponding points from the first and the second free-form surfaces;
(f) generally localizing the first free-form surface to the second free-form surface;
(g) selecting the corresponding points from those corresponding regions;
(h) fine localization of the first surface to the second surface;
(i) determining the difference between the points in each pair of the corresponding point sets.

2. The method of claim 1 wherein the localization of the first free-form surface to the second free-form surface is accomplished by a process consisting of two steps: general localization and fine localization.

3. The method of claim 2 wherein the general localization is determined based on the corresponding point pairs from the corresponding regions of the first free-form surface and the second free-form surface.

4. The method of claim 2 wherein the fine localization is accomplished by an iterative process.

5. The method of claim 1 wherein the comparing of free-form geometries uses high-density point models.

6. The method of claim 1 wherein the first free-form surface has an arbitrary initial position with respect to the second free-form surface.

7. The method of claim 1 wherein the first free-form surface is transformed in three translations and three rotations simultaneously.

8. The method of claim 1 wherein the first free-form surface or the second free-form surface can be either equal or only a portion of another.

9. The method of claim 1 wherein the determination of corresponding regions includes comparison of the geometric characteristics including Gaussian curvature, mean curvature, principle curvatures, shape index, shape scale and the regional areas.

10. The method of claim 9 wherein the region on the first free-form surface and the region of the second free-form surface having the smallest difference between the selected geometric characteristics are marked as matching regions.

11. The method of claim 3 wherein corresponding points for general localization are determined from the relative average center points of the corresponding regions.

12. The method of claim 4 wherein corresponding points are determined based on their most similar surface characteristics and closest distances from inside the corresponding regions.

13. The method of claim 3 wherein general localization includes the determination of a transformation matrix based on corresponding points using a least square model.

14. The method of claim 4 wherein fine localization includes determination of a transformation matrix based on the corresponding points using a least square model with an Iterative Closest Points algorithm.

15. The method of claim 13 or 14 wherein the transformation matrix is determined by solving a set of linear equations.

16. The method of claim 12 wherein the solutions for determination of the closest points can always be obtained by grid subdivision method.

17. A system for comparing a first free-form surface with a second free-form surface, comprising:
(a) means for extracting surface information from each of the first and second free-from surfaces for determining surface characteristics;
(b) means for partitioning each of the first and second free-form surfaces into at least three regions, wherein each region is characterized by a surface characteristic(s);
(c) means for each of the first and the second free-from surfaces, determining the position of each region relative to other regions;
(d) means for comparing regions of the first free-form surface regions with those of the second free-form surface to determine corresponding regions;
(e) means for determining at least three pairs of corresponding points from the first and the second free-form surfaces;
(f) means for generally localizing the first free-form surface to the second free-form surface;
(g) means for selecting the corresponding points from those corresponding regions;
(h) means for fine localization of the first surface to the second surface;
(i) determining the difference between the points in each pair of the corresponding point sets.

18. A storage medium encoded with machine-readable computer program code for comparing a first free-form surface with a second free-form surface, the storage medium including instructions for causing a computer system to implement a method comprising the steps of:
(a) extracting surface information from each of the first and second free-from surfaces for determining surface characteristics;
(b) partitioning each of the first and second free-form surfaces into at least three regions, wherein each region is characterized by a surface characteristic(s);
(c) determining the position of each region relative to other regions for each of the first and the second free-from surfaces;
(d) means for comparing regions of the first free-form surface regions with those of the second free-form surface to determine corresponding regions;
(e) determining at least three pairs of corresponding points from the first and the second free-form surfaces;
(f) generally localizing the first free-form surface to the second free-form surface;
(g) selecting the corresponding points from those corresponding regions;
(h) fine localizing the first surface to the second surface;
(i) determining the difference between the points in each pair of the corresponding point sets.
